(19) United States
(12) Patent Application Publication
(10) Pub. No.: US 2023/0400652 A1
(43) Pub. Date: Dec. 14, 2023

(54) Heteroepitaxially Integrated Compound Semiconductor Optical Devices with On-Chip Waveguides

(71) Applicant: Massachusetts Institute of Technology, Cambridge, MA (US)

(72) Inventors: Christopher Heidelberger, Watertown, MA (US); Cheryl Marie SORACE-AGASKAR, Bedford, MA (US); Jason PLANT, Merrimack, MA (US); Boris KHARAS, Needham, MA (US); Reuel B. SWINT, Billerica, MA (US); Yifei Li, Walpole, MA (US); Paul William JUODAWLKIS, Arlington, MA (US)

(21) Appl. No.: 18/317,597

(22) Filed: May 15, 2023

Related U.S. Application Data
(60) Provisional application No. 63/341,495, filed on May 13, 2022.

(51) Int. Cl. G02B 6/43; G02B 6/42

(52) U.S. Cl. CPC G02B 6/43; G02B 6/4283; G02B 6/4295

(57) ABSTRACT

A III-V/SiNₓ hybrid integrated photonics platform is described. A wafer can include regions where SiNₓ waveguides are formed and regions where III-V waveguides have been grown heteroepitaxially from the Si substrate and formed lithographically to butt couple to the SiNₓ waveguides. Efficient optical coupling is possible between the SiNₓ and III-V waveguides (−2.5 dB loss/transition). A threading dislocation density (TDD) as low as 4×10⁶ cm⁻² can be obtained in the III-V waveguides. The TDD enables fully parallel fabrication of integrated III-V optoelectronic devices, allowing for complex photonic integrated circuits with many active components.

### CROSS-REFERENCE TO RELATED APPLICATION(S)

This application claims the priority benefit, under 35 U.S.C. 119(e), of U.S. Application No. 63/341,495, titled “Heteroepitaxially Integrated Compound Semiconductor Optical Devices with On-Chip Waveguides,” filed on May 13, 2022, which application is incorporated herein by reference in its entirety.

### GOVERNMENT SUPPORT

This invention was made with government support under FA8702-15-D-0001 awarded by the U.S. Air Force. The government has certain rights in the invention.

### BACKGROUND

Photonic integrated circuits (PICs) with silicon nitride (SiNₓ) waveguides provide a useful alternative to PICs with silicon (Si) waveguides for applications involving high optical powers, low loss (e.g., microwave photonics, chip-scale LIDAR), or use of visible wavelengths (e.g., atomic or biological applications). However, while SiNₓ excels in passive device performance and scalability, it cannot emit or detect light and cannot modulate light efficiently. III-V semiconductors (e.g., GaAs, InP) can be used to make state-of-the-art active optoelectronic components, but the scaling potential of full III-V PICs is limited.

### SUMMARY

A hybrid PIC with passive components comprising CMOS-compatible materials (such as silicon (Si), silicon nitride (SiNₓ), or alumina (Al₂O₃)) and III-V semiconductor active components could offer the benefits of both classes of passive and active materials. For example, high-performance and scalable passive components can be implemented on a substrate alongside active devices that can emit, modulate, and/or detect light. Patterned heteroepitaxy of III-V films on a Si substrate is an attractive method of integration because it enables fully parallel fabrication of many III-V devices across a large Si wafer, a major benefit over other III-V integration approaches such as pick-and-place integration or heterogeneous integration by III-V layer transfer. There have been demonstrations of III-V optoelectronic devices grown on Si substrates exhibiting performance comparable to those grown on native substrates. To date, however, there has been no demonstration of a III-V device that is heteroepitaxially integrated with Si or SiNₓ waveguides with low optical transition loss.

Heteroepitaxial device integration with efficient optical transitions between high-quality epitaxial III-V heterostructures and integrated SiNₓ waveguides is described herein. Heteroepitaxially integrated GaAs/Al_{0.4}Ga_{0.6}As waveguides can be implemented that have a low optical coupling loss of 2.5 dB per III-V/SiNₓ transition (λ=674 nm or 1550 nm) and threading dislocation density as low as 4×10⁶ cm⁻² or even lower, which is sufficient for high-performance emitters, optical modulators, and detectors.

For instance, these efficient optical transitions can be implemented in a PIC comprising a silicon substrate, a cladding material on the silicon substrate, a waveguide formed in the cladding material, a III-V semiconductor material grown epitaxially on the silicon substrate bordering the cladding material, and a III-V semiconductor waveguide formed in the III-V semiconductor material and butt-coupled to the waveguide.

The silicon substrate can be a (100) silicon substrate that is offcut at an angle of approximately or exactly 6° towards the nearest [111] directions (or the symmetric equivalents, such as the [1 −1 1] directions, [1 1 −1] directions, or [1 −1 −1] directions of the silicon substrate. The cladding material can comprise an oxide (e.g., silicon oxide). The waveguide can comprise silicon, silicon nitride, germanium, lithium niobate, aluminum oxide, or titanium oxide.

The III-V semiconductor waveguide can have a threading dislocation density (TDD) of about 1×10⁶ cm⁻² to about 1×10⁹ cm⁻² (e.g., about 4×10⁶ cm⁻²). The coupling loss between the waveguide and the III-V semiconductor waveguide can be less than or equal to 10 dB (e.g., 0.5 dB, 1 dB, 2.5 dB, or in the range of 0.1-10 dB). The waveguide and/or the III-V semiconductor waveguide can be oriented parallel to a [011] direction of the silicon substrate. The waveguide and/or a facet between the III-V semiconductor material and the cladding layer can be angled with respect to the III-V semiconductor waveguide. The waveguide can also be patterned to reduce back reflections and/or to increase coupling into the III-V semiconductor waveguide.

The PIC can include a germanium layer disposed between the silicon substrate and the III-V semiconductor waveguide. The PIC can also include a dislocation filter disposed in the III-V semiconductor material between the silicon substrate and the III-V semiconductor waveguide. The PIC can further include electrical contacts in electrical communication with the III-V semiconductor material, in which case the III-V semiconductor material forms at least a portion of an active optoelectronic device, such as a laser, semiconductor optical amplifier, optical modulator, or photodetector.

Some implementations relate to a photonic integrated circuit comprising: a silicon substrate; a cladding material disposed on the silicon substrate; a waveguide formed in the cladding material; a III-V semiconductor material grown epitaxially on the silicon substrate bordering the cladding material; and a III-V semiconductor waveguide formed in the III-V semiconductor material and butt-coupled to the waveguide.

Some implementations relate to a method of making a photonic integrated circuit. The method can include acts of: depositing a first cladding layer on a silicon substrate; forming a first waveguide on the first cladding layer; depositing a second cladding layer on the first waveguide; etching a trench through the second cladding layer, at least a portion of the first waveguide, and the first cladding layer, wherein etching through the first waveguide forms a first end of the first waveguide; epitaxially growing a III-V semiconductor material in the trench; and forming a second waveguide from at least a portion of the III-V semiconductor material, the second waveguide having a second end that is vertically aligned with and butt-coupled to the first end of the first waveguide.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A is an elevation view depicting a portion of a wafer that includes III-V/SiNₓ heteroepitaxially-integrated and optically-coupled waveguides for an optical device.

FIG. 1B is a cross section of the structure of FIG. 1A.

FIG. 1C is another cross section of the structure of FIG. 1A.

FIG. 2A, FIG. 2B, FIG. 2C, FIG. 2D, FIG. 2E, and FIG. 2F depict structures associated with fabrication of heteroepitaxially-integrated optical devices.

FIG. 3A shows a cross-section scanning electron microscope (SEM) image of III-V/SiNₓ transition, showing good vertical alignment between GaAs and SiNₓ waveguides and near-planarity of III-V layers.

FIG. 3B is another SEM image (in a perspective view) of a III-V/SiNₓ optical transition.

FIG. 4A is an electron channeling contrast imaging (ECCI) image of a GaAs/AlGaAs double heterostructure (DH) on Si with no dislocation filter.

FIG. 4B is a cathodoluminescence (CL) image of a GaAs/AlGaAs DH on Si with an InGaAs dislocation filter layer.

FIG. 5 depicts an active heteroepitaxially-integrated optical device that includes electrical contacts to the III-V semiconductor material.

FIG. 6A, FIG. 6B, FIG. 6C, and FIG. 6D show cross-section SEM images of selectively grown GaAs layers at different growth temperatures.

FIG. 6E and FIG. 6F show cross-section SEM images of selectively grown GaAs layers at different growth rates.

FIG. 7A includes a depiction (top) of a III-V semiconductor region and adjacent cladding material where the waveguide is oriented in the [1-1 0] direction relative to the (001) surface of the silicon substrate and also includes an SEM image (bottom) showing faceted epitaxial growth of GaAs for this waveguide orientation.

FIG. 7B includes a depiction (top) of a III-V semiconductor region and adjacent cladding material where the waveguide is oriented in the [110] direction relative to the (001) surface of the silicon substrate and also includes an SEM image (bottom) showing epitaxially grown GaAs that contacts the cladding material for this waveguide orientation.

FIG. 8 is a plot of measured optical loss versus number of III-V/SiNₓ transitions (λ=1550 nm) for both near vertical alignment of III-V and SiNₓ waveguides (diamonds) and a 300 nm misalignment (squares). The plot also includes measured optical loss at λ=674 nm for near vertical alignment (triangles).

FIG. 9 is a plot of simulated and measured III-V/SiNₓ transition loss versus vertical misalignment.

FIG. 10A depicts a III-V semiconductor waveguide aligned at an angle with respect to a SiNₓ waveguide to reduce facet reflections.

FIG. 10B plots facet reflection (as return loss) as a function of facet tilt angle for butt-coupled SiNₓ and III-V semiconductor waveguides.

FIG. 10C depicts vertically-angled facets of the butt-coupled SiNₓ and III-V semiconductor waveguides.

FIG. 11A depicts an approach to including an anti-reflection coating between ends of butt-coupled SiNₓ and III-V semiconductor waveguides.

FIG. 11B depicts another approach to including an anti-reflection coating between ends of butt-coupled SiNₓ and III-V semiconductor waveguides.

FIG. 11C plots coupling loss as a function of distance (gap width) between ends of butt-coupled SiNₓ and III-V semiconductor waveguides for the arrangement of FIG. 11B.

FIG. 11D plots a simulated optical mode in the SiNₓ waveguide used for the computations of FIG. 11C.

FIG. 11E plots a simulated optical mode in the III-V semiconductor waveguide used for the computations of FIG. 11C.

FIG. 12A depicts an example of III-V/SiNₓ heteroepitaxially-integrated photonic circuitry that can be used in a quantum computing system.

FIG. 12B depicts further details of the heteroepitaxially-integrated photonic circuitry of FIG. 12A.

### DETAILED DESCRIPTION

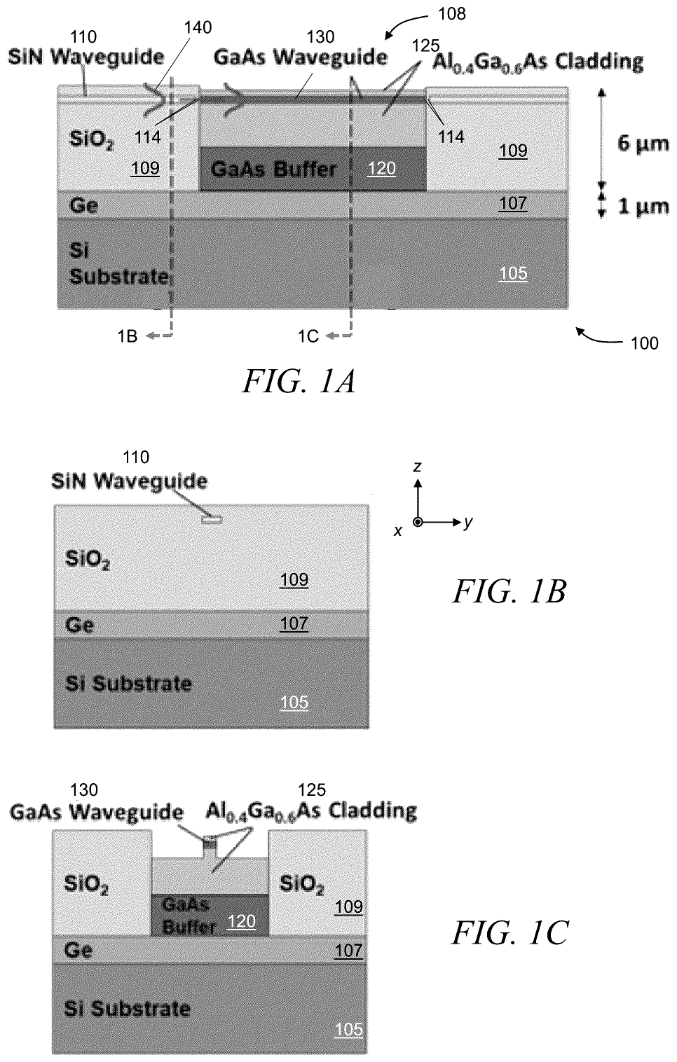

FIG. 1A illustrates, in elevation view, an integrated structure 100 that can be formed on a portion of a wafer. The integrated structure 100 includes III-V/SiNₓ heteroepitaxially-integrated and optically-coupled waveguides 110, 130 that can be used for an integrated photonic device. Cross-section, elevation views of the structure, taken at the dashed lines, are shown in FIG. 1B and FIG. 1C.

The integrated structure 100 includes a silicon substrate 105 on which III-V semiconductor material is epitaxially grown and/or deposited. A seed layer 107 (germanium in this example) can be epitaxially grown on the silicon substrate 105, though may not be used in some applications. The integrated structure 100 further includes regions of cladding material 109 that can comprise an oxide such as SiO₂. The regions of cladding material 109 can be adjacent to a III-V region 108 that includes the III-V semiconductor material epitaxially grown on the seed layer 107 (or grown on the silicon substrate 105 if the seed layer 107 is not used). A first waveguide 110 (silicon nitride in this example) is formed in the regions of cladding material 109 and a second waveguide 130 (gallium arsenide in this example) is formed in the III-V region 108. At least the butt-coupled ends 114 of the first waveguide 110 and the second waveguide 130 are aligned vertically and horizontally to optically couple to each other, such that an optical mode 140 can propagate along the coupled waveguides with low coupling loss (e.g., less than 10 dB in optical power) at the junction(s) where the waveguides butt couple to each other. Cladding layers 125 can be included below and above the second waveguide 130. A buffer layer 120 can also be included above the seed layer 107 and/or silicon substrate 105.

The illustrated silicon substrate 105 can be part of a standard semiconductor-grade wafer used in microfabrication processes, such as in complementary metal-oxide-semiconductor (CMOS) fabrication. Any size wafer may be used (e.g., from 100 mm diameter to 300 mm diameter and larger) so that many integrated photonic devices can be formed on a single wafer. According to some implementations, the wafer is approximately or exactly (100) oriented silicon but can be selectively offcut to promote single-domain epitaxial growth of the III-V material. For epitaxial growth of gallium arsenide (GaAs), the offcut angle can be from 0.1 degree up to approximately or exactly 8° toward the nearest <111> direction. According to some implementations, the offcut angle is approximately or exactly 6° toward the nearest <111> direction. Other orientations may be used for epitaxial growth of other III-V materials (e.g., (111) silicon wafers would be used for gallium nitride growth). The silicon substrate 105 can be part of a bulk silicon wafer or a silicon-on-insulator (SOI) wafer.

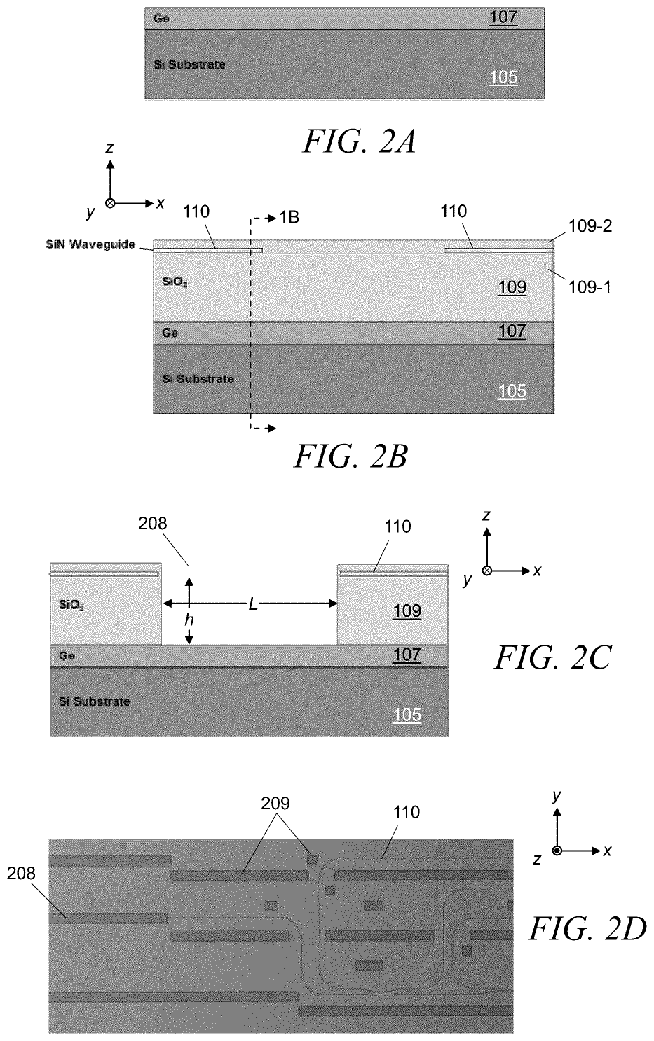

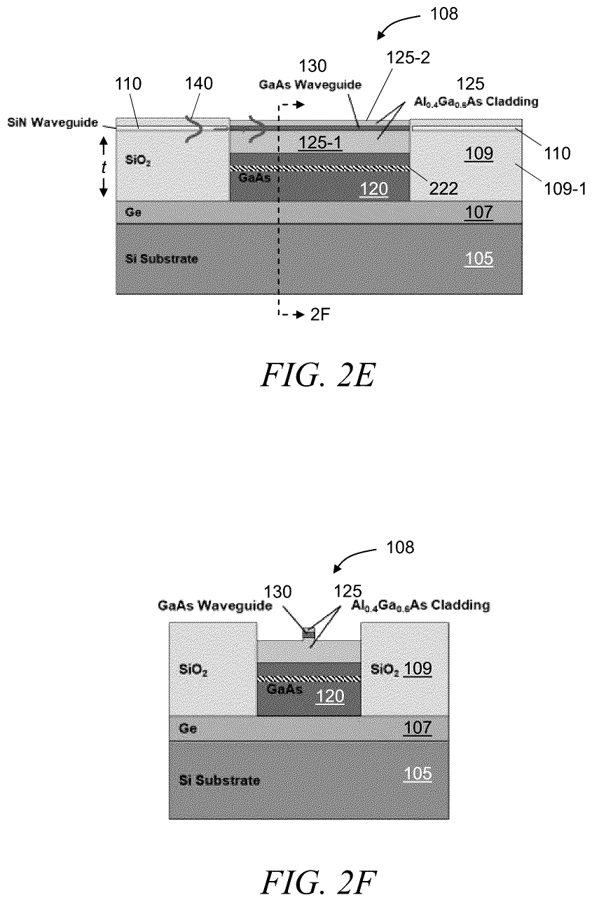

FIG. 2A through FIG. 2F depict structures associated with microfabrication of heteroepitaxially-integrated photonic devices. FIG. 2A depicts a portion of a wafer on which the seed layer 107 has been grown. The seed layer 107 can be grown on the silicon substrate 105 to a thickness between 50 nanometers (nm) and 2 microns (μm). Use of a seed layer may reduce defects (such as threading dislocations) in the subsequently grown III-V material. A semiconductor seed layer 107 such as germanium can be grown using chemical vapor deposition (CVD), whereas a III-V buffer layer 120 can be grown using organo-metallic vapor phase epitaxy, also known as metalorganic chemical vapor deposition (MOCVD). In some cases, the seed layer 107 can be grown by atomic layer deposition (ALD) or molecular beam epitaxy (MBE). After growth, the seed layer 107 may or may not be planarized. For example, chemical mechanical polishing (CMP)) can be used to produce a smooth and flat surface for subsequent epitaxy. As noted above, the seed layer 107 may not be used in some cases. In some implementations, the seed layer may be grown only in the III-V regions 108 where the III-V material is subsequently grown. In other implementations, the seed layer 107 may be grown across an entire wafer.

In the following example, a germanium seed layer 107 is used for subsequent epitaxial growth of GaAs materials. Other seed layers can be used for GaAs or other III-V materials. Another material that may be used for the seed layer 107 is gallium phosphide (GaP).

FIG. 2B depicts the structure after deposition of first and second layers of an oxide 109-1, 109-2 (silicon oxide in this example, to form the region(s) of cladding material 109 on the seed layer 107 (if present)) and after formation of the waveguides 110. In other implementations, the layers of oxide can be deposited directly on the silicon substrate 105 if a seed layer is not present. The layers of oxide 109-1, 109-2 can be deposited by a chemical vapor deposition (CVD) process, such as plasma-enhanced chemical vapor deposition (PECVD). The thickness of the oxide can be from 2 microns to 6 microns. The first layer of oxide 109-1 can be planarized after deposition using a CMP process.

Silicon nitride waveguides 110 can be formed on the first layer of oxide 109-1 using conventional photolithography processes. For example, a layer of SiNₓ having a thickness between 100 nm and 700 nm can be deposited on the oxide. Waveguides 110 can be patterned in the SiNₓ layer using photolithography and reactive ion etching (RIE), for example. A covering layer of oxide 109-2 can then be deposited using a CVD process, forming a cladding layer over the patterned waveguides 110. A cross section, elevation view of the patterned waveguide (taken at the dashed line in FIG. 2B) is the same as that shown in FIG. 1B. Although two waveguides are shown in FIG. 2B, one continuous waveguide can be formed across the entire region where III-V material will be subsequently grown. Alternatively, the waveguide 110 may only extend from one side of the region where III-V material will be subsequently grown. Materials other than silicon nitride can be used to form the first waveguides 110. Such materials include, but are not limited to, silicon, aluminum oxide, titanium oxide, and lithium niobate.

Trenches 208 can then be etched into and through the layers of oxide 109-1, 109-2 (and first waveguide 110 if present) as depicted in FIG. 2C where III-V regions 108 will be formed. Photolithography and RIE can be used to pattern and etch the trenches 208 at selected locations on the wafer, such that at least one waveguide 110 extends from some of the trenches 208. The anisotropic etching of RIE can produce essentially vertical sidewalls in the trenches which are suitable for butt coupling the first waveguide 110 and second waveguide 130 when formed. The trenches 208 can have a width (along they axis, into the drawing sheet) between 5 microns and 100 microns and a length L between 50 microns and 10 millimeters (mm), though larger or smaller dimensions are possible. The trenches 208 can be etched to expose the seed layer 107 (if present) or silicon substrate 105 for subsequent epitaxial growth. In some implementations, the trench can be etched into the silicon substrate (i.e., removing some of the silicon) to deepen the trench.

There can be many trenches 208 patterned on a wafer, including some “dummy trenches” for which no waveguide extends from the trench. The dummy trenches can be distributed around trenches having waveguides extending from the trench to improve the uniformity of epitaxial growth rates in all trenches on the wafer. FIG. 2D is a plan view of the surface of a wafer showing a trench 208, waveguides 110, and dummy trenches 209.

There may be more dummy trenches 209 containing no devices than trenches 208 that each can be used to form one or more devices. The dummy trenches can be added and arranged such that an average fill factor of the trenches for 500-micron square sections taken anywhere across the wafer remains the same to within 10% or less or even to within 1% or less. The trench 208 and dummy trenches 209 in FIG. 2D are 30 microns wide. The inventors found that sizable gaps between trenches (up to 100 microns or more) can still provide uniform epitaxy because the diffusion length of adatoms during epitaxy can be hundreds of microns.

As mentioned above in connection with FIG. 2B, a single waveguide may extend across, up to, or into a region where a trench 208 and III-V region 108 will be formed. In such cases, the etching process can remove a section of the waveguide where the trench 208 is formed. A non-selective etch to the oxide and waveguide can be used to remove both the oxide and waveguide in the etched region.

Epitaxial growth of III-V material can then proceed in the etched trenches, as depicted in FIG. 2E. In some implementations, when a seed layer 107 is not grown on the bare wafer as depicted in FIG. 2A, the seed layer 107 can be grown in the trenches 208, 209 on the exposed silicon. The epitaxial growth of III-V material can include growing a buffer layer 120 on the seed layer 107 (or silicon substrate 105 if a seed layer is not used). The buffer layer 120 can be substantially thicker than the seed layer 107. For example, the buffer layer 120 can have a thickness from 2 microns to 6 microns. In some implementations, the buffer layer can be between 3 microns and 5 microns thick. A thick buffer layer can reduce defects arising from lattice mismatch between the silicon substrate 105 and/or seed layer 107 and the epitaxially-grown III-V material. When a thicker buffer layer 120 is needed, the etching step to form the trenches 208 (described above in connection with FIG. 2C) can be extended into the silicon substrate to deepen the trenches 208. To further improve uniformity of III-V growth across wafers in a batch, the wafers can be arranged in a ring in the epitaxy chamber on a platen that rotates during epitaxial growth.

In some implementations as illustrated in FIG. 2E, the buffer layer 120 can include a defect filtration layer 222. The defect filtration layer 222 may reduce certain defects (such as dislocations) in subsequently-grown material. An example of a defect filtration layer 222 is a 200-nm-thick layer of indium-gallium-arsenide having a low indium stochiometric ratio (e.g., less than 0.2) for a GaAs buffer layer. Other thicknesses (e.g., from 50 nm to 400 nm) can be used for the filtration layer 222. In some cases, the buffer layer 120 can include a strained layer of material that acts as a defect filtration layer. For example, the amount of strain in the example indium-gallium-arsenide filtration layer 222 can be determined by the indium fraction. The indium fraction and layer thickness can be chosen to be high enough so that existing dislocations move around, increasing chance of interacting with each other and annihilating, but low enough that new dislocations are not formed. Such filter layers can reduce threading dislocations by an order of magnitude or more.

A lower cladding layer 125-1 can then be grown on the buffer layer 120 and/or filtration layer 222. The lower cladding layer 125-1 can be a different III-V material (e.g., a different alloy) from the III-V material of the buffer layer 120. The lower cladding layer may have a thickness from 500 nm to 3 microns. In the illustrated example of FIG. 2E, the lower cladding layer 125-1 comprises aluminum gallium arsenide, which can be used as a cladding layer for a gallium arsenide second waveguide 130. Generally, the lower cladding layer 125-1 has an optical refractive index that is lower in value than the refractive index of the second waveguide 130. Including aluminum in the alloy can reduce the refractive index of the lower cladding layer 125-1. In the illustrated example, the stoichiometric ratio of aluminum to gallium in the alloy is 0.4:0.6. Other ratios may be used in some cases (e.g., from 0.2:0.8 to 0.8:0.2). The thickness of the lower cladding layer 125-1 may also aid in reducing defects in the second waveguide 130. For example, a thicker lower cladding layer 125-1 may allow termination of threading dislocations before reaching the second waveguide 130. Other materials and/or stoichiometric ratios may be used for the lower cladding layer 125-1 in other implementations of III-V heteroepitaxially-integrated photonic devices.

A layer of III-V material (gallium arsenide in this example) for the optical waveguide 130 can be grown on the lower cladding layer 125-1 followed by growth of the upper cladding layer 125-2. The thickness of the III-V material for the waveguide 130 can be from 50 nm to 600 nm. The thickness of the upper cladding layer 125-2 can be from 200 nm to 3 microns. The upper cladding layer 125-2 can be the same material as or different material from (e.g., different compound semiconductor, different alloy) the lower cladding layer 125-1. Generally, the upper cladding layer 125-2 also has a lower refractive index value than that of the second waveguide 130.

As may be appreciated, the second waveguide 130 should be aligned to the first waveguide(s) 110 to reduce optical coupling losses from the first waveguide 110 to the second waveguide 130 and/or from the second waveguide 130 to the first waveguide 110. There are several ways to vertically align the waveguides 110, 130. One approach is to rely on deposition and growth rates of the first layer of oxide 109-1 and III-V materials in the III-V region 108, respectively. Provided the deposition and growth rates are known and highly reproducible, then the first layer of oxide 109-1 can be deposited to a first thickness t (which can be determined from the deposition rate and time of deposition) before depositing the layer of material for the first waveguide 110. The buffer layer 120 and lower cladding layer 125-1 can later be grown to a same total thickness t based on their respective epitaxial growth rates and times of growth.

In another approach, sacrificial wafers (taken from a batch of concurrently run process wafers) are used to obtain vertical alignment. After the batch has been processed to through the step of etching trenches 208, 209 (see FIG. 2C and FIG. 2D), a first sacrificial wafer can be cleaved and inspected (e.g., in a scanning electron microscope (SEM)) to measure the height h of the lower surface of the first waveguide 110 above the upper surface of the seed layer 107 (if present) or upper surface of the silicon substrate 105. Portions of the first sacrificial wafer or a second sacrificial wafer can then be subjected to epitaxial growth of the buffer layer 120 (which may include a filtration layer 222) and the lower cladding layer 125-1 to obtain nominally a same height h′ based on the growth rates and times of the materials used for the buffer layer 120 and lower cladding layer 125-1. The sacrificial wafer with grown III-V material can then be cleaved and inspected as before to determine how close the growth height h′ is to the measured height h. Any difference can be compensated for in a subsequent growth process for the remaining wafers in the batch.

In another approach, the thickness of the lower cladding layer 125-1 can be measured by optical techniques (e.g. ellipsometry) before the SiN waveguide is deposited. The thickness of the lower cladding layer will establish the height of the bottom of the SiN waveguide. The measured thickness can be used as the target growth thickness for the seed layer 107 and/or buffer layer 120, which will establish the height of the III-V waveguide. A wafer can be sacrificed to establish the accuracy of the growth process as described in the previous paragraph. Fine adjustments can be made to the growth process, if necessary, to effectively match the heights of the III-V and SiNₓ waveguides.

In yet another approach, in situ measurements of deposited first layer of oxide 109-1 and epitaxially grown III-V material can be used to vertically align the first waveguide 110 and the second waveguide 130. An in-situ measurement may utilize multi-wavelength or short coherence length interferometry to monitor the thickness of deposited and grown materials, for example.

After deposition of the upper cladding layer 125-2, the second waveguides 130 can be patterned using photolithography. For example, photoresist can be spun onto the wafer and baked. A photolithography mask having waveguide patterns can be aligned to the wafer such that at least one second waveguide 130 aligns horizontally to a corresponding first waveguide 110. An exposure can then be done to expose the photoresist and pattern the second waveguides 130. The III-V regions 108 can then be etched, using the patterned photoresist as a mask, to form the second waveguides 130 on the wafer.

FIG. 2F depicts an elevation view of the III-V region 108 after patterning the second waveguide 130. The upper cladding layer 125-2, the layer of III-V material for the second waveguide 130, and a portion of the lower cladding layer 125-1 have been etched away on either side of the second waveguide 130 to laterally confine an optical mode in the second waveguide 130. The resulting structure is a ridge waveguide.

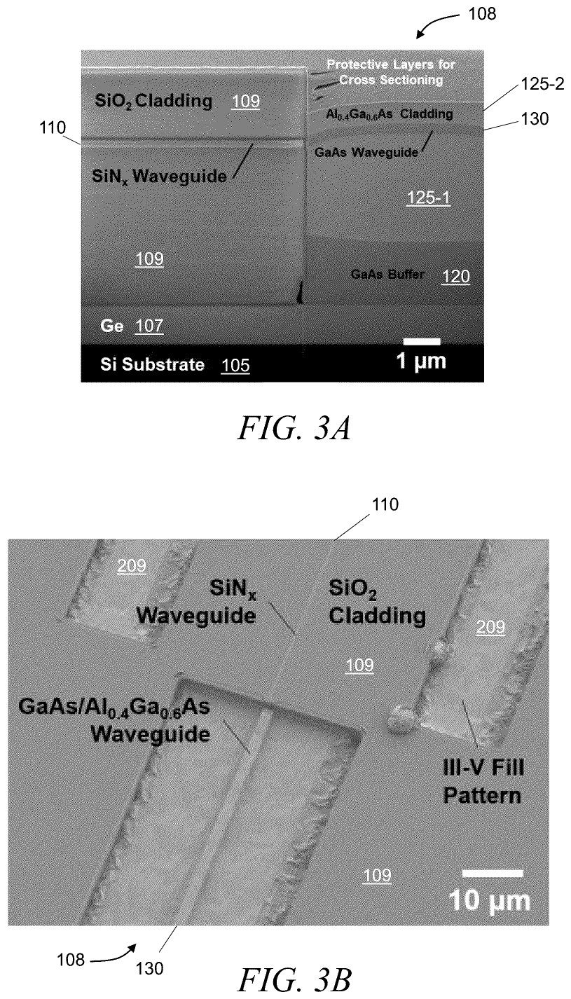

FIG. 3A is a false-color SEM image of a cleaved portion of a wafer showing that the first waveguide 110 and second waveguide 130 can be vertically aligned to high accuracy. The two waveguides are approximately 250 nm thick, and the alignment of the central axes of the two waveguides where they butt couple to one another is better than 100 nm vertically. The second waveguide 130 bows upward in the III-V region due to growth dynamics of the epitaxial layers in that region. In some implementations, the bow (such as that depicted in FIG. 3A) can be advantageous because it causes the waveguides to butt couple at an angle to one another, which can reduce Fresnel reflections from the butt-coupled facets into the waveguides.

FIG. 3B is another SEM image of the wafer in perspective view. Because multi-level mask alignment in photolithography can be accurate, horizontal alignment of the first waveguide 110 and second waveguide 130 can be very accurate (e.g., central axes of the two waveguides can be aligned horizontally to 250 nm (3σ) or better). Several dummy trenches 209 are shown in the image that have been filled with epitaxially-grown III-V materials like those in the III-V region 108.

Although the above examples involve growing gallium arsenide and alloys of gallium arsenide in the III-V region, other compound semiconductors and their alloys can be used in other implementations. Other compound semiconductors that may be used include aluminum gallium arsenide (AlGaAs), gallium phosphide (GaP), indium gallium phosphide (InGaP), indium aluminum gallium phosphide (InAlGaP), indium phosphide (InP), indium gallium arsenide phosphide (InGaAsP), indium gallium arsenide (InGaAs), indium arsenide (InAs), indium arsenide antimonide (InAsSb), indium antimonide (InSb), gallium antimonide (GaSb), gallium nitride (GaN), aluminum gallium nitride (AlGaN), indium gallium nitride (InGaN). Alloys of these semiconductors may also be used in the III-V region 108. In some cases, such as for GaN, the seed layer 107 may comprise aluminum nitride. By selecting different materials, the optical device formed in the III-V region 108 can be operable at different wavelengths, ranging from the ultraviolet (UV) at about 380 nm through the longwave infrared wavelengths to about 10 microns.

Growth of III-V material in the III-V region 108 can exhibit multi-domain growth (e.g., a desired crystallographic domain and its antiphase domain), which may be undesirable in some cases. Steps can be taken to suppress multi-domain growth such that growth of a single crystal domain is preferred. Such steps can include obtaining silicon wafers that are offcut from a crystallographic orientation as described above (e.g., using a (100) silicon wafer that is offcut by approximately or exactly 6 degrees toward the nearest <111> directions, or symmetric equivalents thereof). In some cases, the offcut angle can be between 0.1 degree and 10 degrees, though other wafer orientations and offcut angles can be used for semiconductors other than GaAs. The offcut angle can break fourfold symmetry of the silicon's diamond crystal structure about the [100] direction and thereby break the twofold symmetry of the GaAs zincblende crystal structure about the same direction, suppressing antiphase domains. Another step that can be taken is to maintain high partial pressure (e.g., from 3 mbar to 15 mbar) of a constituent gas (e.g., AsH₃) during the initiation of GaAs formation on the Ge surface. During normal growth of the GaAs after initiation, the partial pressure may be from 0.25 mbar to 1 mbar, for example. Another step is to engineer the III-V regions 108 to preferentially grow the desired crystallographic domain and suppress the anti-phase domain. Such engineered III-V regions can include grooves, microscale patterns, or sub-microscale patterns formed in the silicon substrate 105. In some cases, the shape of the mask used to pattern the III-V regions can suppress antiphase domains as described in B. Shi, B. Song, A. A. Taylor, S. S. Brunelli, and J. Klamkin, “Selective area heteroepitaxy of low dislocation density antiphase boundary free GaAs microridges on flat-bottom (001) Si for integrated silicon photonics,” Appl. Phys. Lett., vol. 118, no. 12, p. 122106, March 2021, which publication is herein incorporated by reference in its entirety.

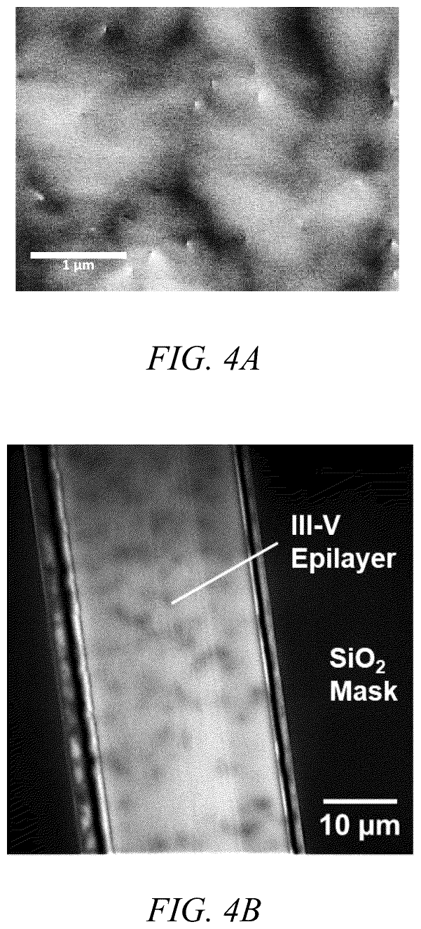

As described above, the use of a filtration layer 222 can reduce defects in the second waveguide 130, which may be part of an optical device. Generally, device performance improves with reduction of defects in the semiconductor material. FIG. 4A is an electron channeling contrast image of the surface of the epitaxially-grown GaAs at the location of the second waveguide 130 (about 6 microns from the surface of the silicon substrate 105). A 1-micron thick germanium seed layer was used, and the GaAs layer was about 5 microns thick. The image indicates that the density of threading dislocations is on the order of 5×10⁷ cm⁻². No filtration layer 222 was included in the buffer layer 120 for this image.

FIG. 4B is a cathodoluminescence image of the surface of epitaxially-grown GaAs on a second wafer at the location where the second waveguide 130 will be formed (also about 6 microns from the surface of the silicon substrate 105). A 1-micron thick germanium seed layer was used and a 200-nm thick filtration layer 222 as described above was included in the GaAs layer that, together with the filtration layer, had a total thickness of about 5 microns. The filtration layer was located about 2.5 microns below the imaged GaAs surface. The image indicates that the density of threading dislocations is on the order of 4×10⁶ cm⁻², a reduction in threading dislocation defects by more than an order of magnitude. This level of dislocations is sufficient for fabrication of high-performance active optoelectronic devices, such as lasers and optical amplifiers.

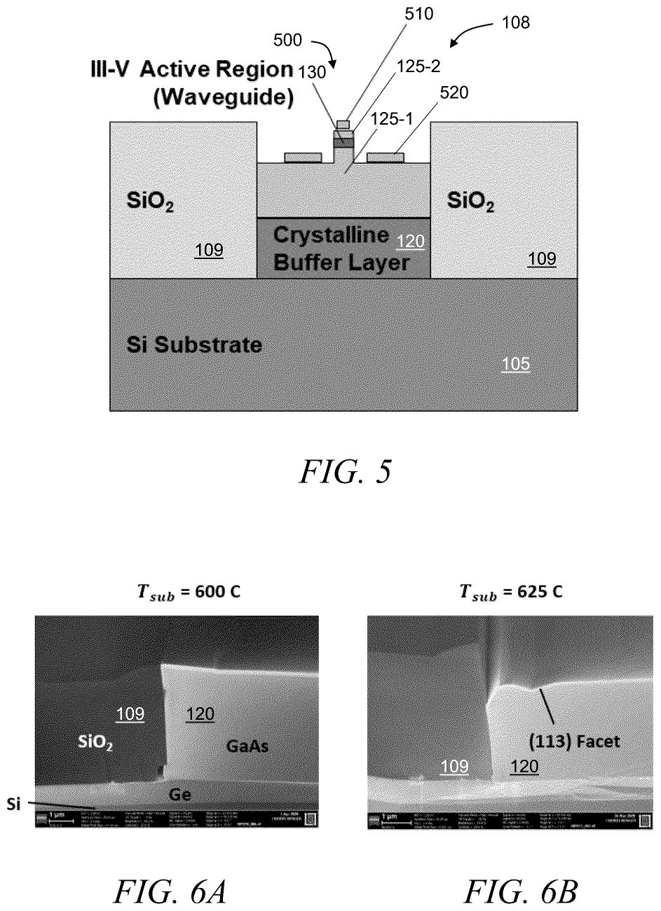

Passive and/or active optical devices can be formed in the III-V region 108. Active devices include, but are not limited to, lasers, semiconductor optical amplifiers, modulators, and photodetectors. After making the ridge waveguide (which can be part of an integrated laser, optical amplifier, optical modulator, or photodetector, for example), metal electrodes can be deposited and patterned using standard photolithography processes to make electrical contact to the optical device. FIG. 5 depicts an example of an active optical device 500 having electrical contacts 510, 520. In this example, the second waveguide 130 includes an active region into which carriers can be injected by applying a voltage across the electrical contacts 510, 520. The active region may be part of an integrated semiconductor laser, an optical amplifier, an optical modulator, or even a photodetector (having a pn junction formed along the waveguide). The photodetector can be reverse biased in some cases using the electrical contacts 510, 520 for higher speed operation. For the photodetector, photogenerated carriers in the waveguide can be detected via the electrical contacts 510, 520. Layers of dielectric material can be deposited above the device for protection, passivation, and/or electrical isolation. Metallization levels can also be patterned over the device.

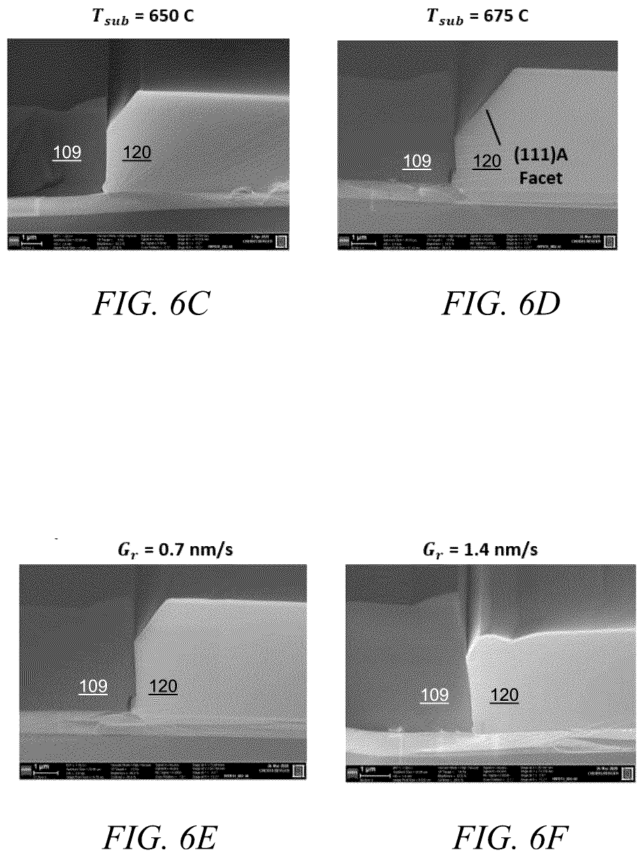

The inventors found that waveguide orientation and epitaxial growth conditions for the III-V materials can affect the formation of and optical coupling efficiency to the second waveguide 130 in the III-V region 108. Temperature and growth rate were changed for different growth processes to improve epitaxial growth of III-V materials in the trench 208 (see FIG. 2C and FIG. 2E). FIG. 6A through FIG. 6F shows the results of the different growth temperatures (from 600° C. to 675° C.) and growth rates. Temperatures above about 620° C. cause thermodynamically driven higher-order faceting (appearance of (113) and (111) facets) between the cladding material 109 and GaAs buffer layer 120. Such facets are unwanted. Lower temperature growth (from approximately or exactly 550° C. to approximately or exactly 610° C.) exhibits more uniform fill in the etched trenches 208, which improves butt-coupling of the first waveguide 110 to the second waveguide 130. Temperatures below this range resulted in higher overall surface roughness and lower crystalline quality. The results from changing growth rate at a fixed temperature of 625° C. are shown in FIG. 6E and FIG. 6F. The images show that different faceting occurs when the growth rate is reduced from 1.4 nm/s to 0.7 nm/s. The faceting appears to change from (113) in FIG. 6F to (111) in FIG. 6E.

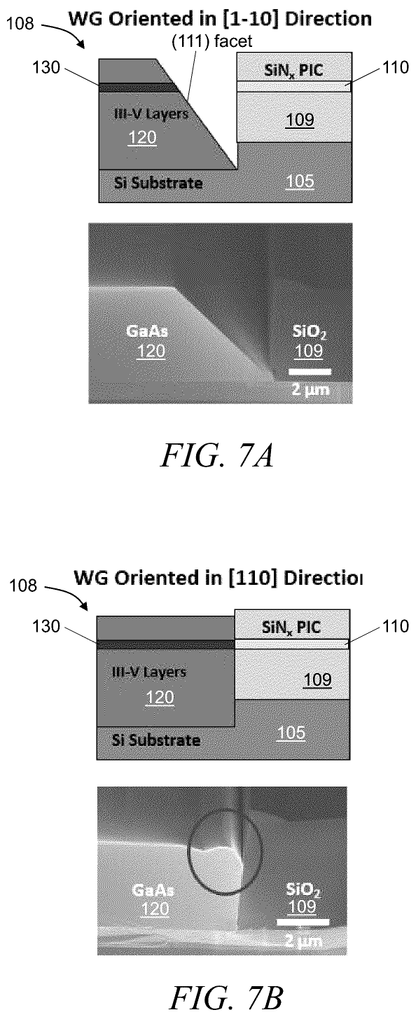

The effect of waveguide orientation is shown in FIG. 7A and FIG. 7B. FIG. 7A includes a depiction (top drawing) of the III-V region 108 and adjacent cladding material 109 where the waveguide is oriented in the [1-1 0] direction relative to the (001) surface of the silicon substrate 105. Because of the waveguide orientation, {111} faceting occurs on the epitaxially-grown III-V material in the III-V region 108, which is observed in the SEM image (lower image) in FIG. 7A. This faceting can form a gap between the III-V material and first waveguide 110, adversely affecting coupling efficiency between the first waveguide 110 and second waveguide 130.

By changing the orientation of the waveguide 90 degrees, to the [110] direction, the {111} faceting can be reduced, as shown in FIG. 7B. Some faceting is still observed in the SEM image of FIG. 7B. However, that faceting may be further suppressed by changing growth temperature (e.g., as shown in FIG. 6A). Below the surface where faceting occurs, the buffer layer 120 grows in sufficient contact with the vertical sidewall of the cladding material 109 to enable low-loss butt coupling of waveguides.

Example devices were fabricated on (100) silicon wafers that were offcut by 6 degrees toward the [111] direction, as described above. For the second waveguide, a GaAs/Al_{0.4}Ga_{0.6}As double heterostructure (DH) was epitaxially grown to provide vertical confinement in the III-V regions 108, with the GaAs waveguide layer vertically aligned to the SiNₓ waveguide 110. A 1.5-μm-tall ridge waveguide was etched in the DH (shown in FIG. 3B). Finally, a 150-nm-thick SiO₂ layer was deposited over the upper Al_{0.4}Ga_{0.6}As cladding layer 125-2 and upper oxide cladding layer above the SiNₓ waveguide 110.

FIG. 3A shows a longitudinal cross-section, false-color SEM image for one of the example devices (before forming the III-V waveguide) and shows accurate vertical alignment (less than 50 nm misalignment) between the III-V and SiNₓ waveguide layers. The threading dislocation density (TDD) of the as-grown III-V regions was measured by electron channeling contrast imaging (ECCI) and cathodoluminescence (CL) with good agreement between both methods. Samples that contained a 200-nm-thick In_{0.1}Ga_{0.9}As dislocation filter layer had a TDD of about 4×10⁶ cm⁻², sufficiently low to enable fabrication of active optoelectronic devices such as lasers and photodetectors.

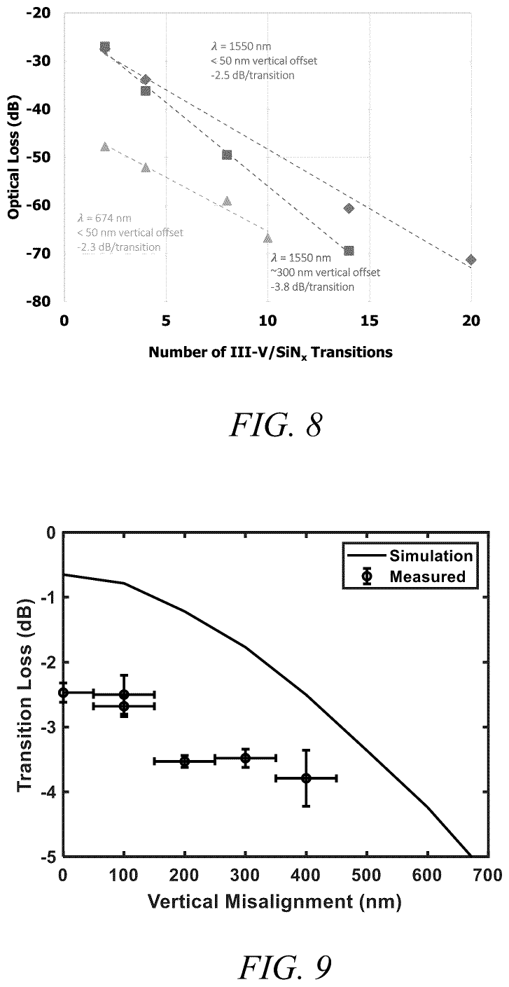

Test structures with varying numbers of III-V/SiNₓ waveguide-to-waveguide transitions were fabricated having constant III-V and SiNₓ waveguide lengths. These structures were used to determine loss per transition for several vertical alignments between the SiNₓ waveguide 110 and III-V waveguide 130. The vertical alignments ranged from near-perfect alignment to 400 nm misalignment. Measurements were made on separate structures at two wavelengths λ=1550 nm and λ=674 nm. Measurement results are plotted in FIG. 8.

With approximately 50 nm vertical misalignment, the measured transition loss is −2.5 dB per transition at 1550 nm wavelength and −2.3 dB per transition at 674 nm wavelength. With a 300 nm vertical misalignment, the measured transition loss is −3.8 dB per transition at 1550 nm wavelength. Polycrystalline formation of the upper cladding layer at the butt-coupling transition was observed in SEM images, which may account for some of the transition loss. Suppressing or removing the polycrystalline material may reduce the transition loss further. Surface roughness of the upper cladding layer was also observed and suspected to contribute to propagation loss in the III-V waveguides.

Simulations of III-V/SiNₓ transition loss vs. vertical misalignment were carried out. The simulations assumed perfect horizontal alignment and considered the effect of Fresnel reflections at the butt coupled waveguides, which have different refractive indices. Results of the simulations are plotted in FIG. 9 along with data from measurements made on the test structures. Degradation in measured transition loss with increasing vertical misalignment shows similar curvature and slop to the simulation, but measured values are 1-1.5 dB lower than expected. The differences may be due to other loss mechanisms such as SiNₓ taper loss, differences in waveguide shape, presence of polycrystalline material at the butt-coupling region, and waveguide orientation (e.g., not co-linear).

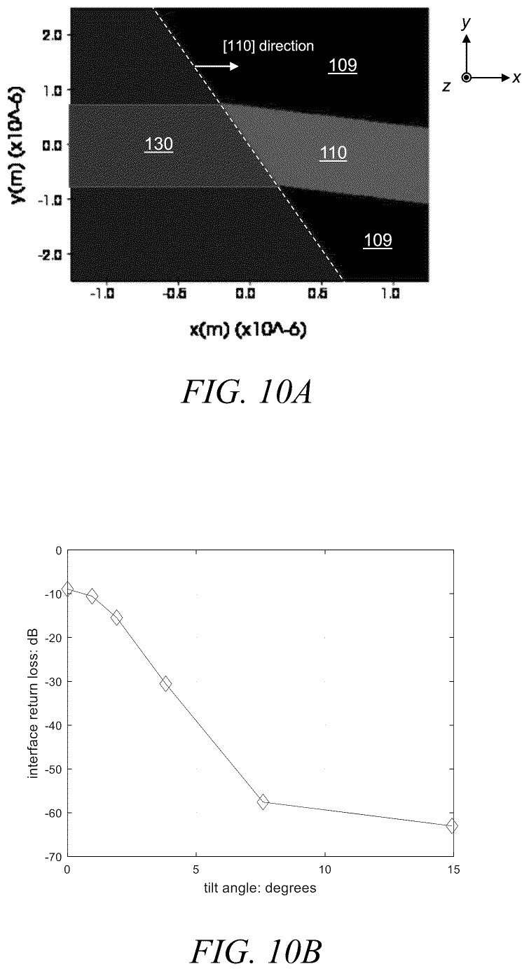

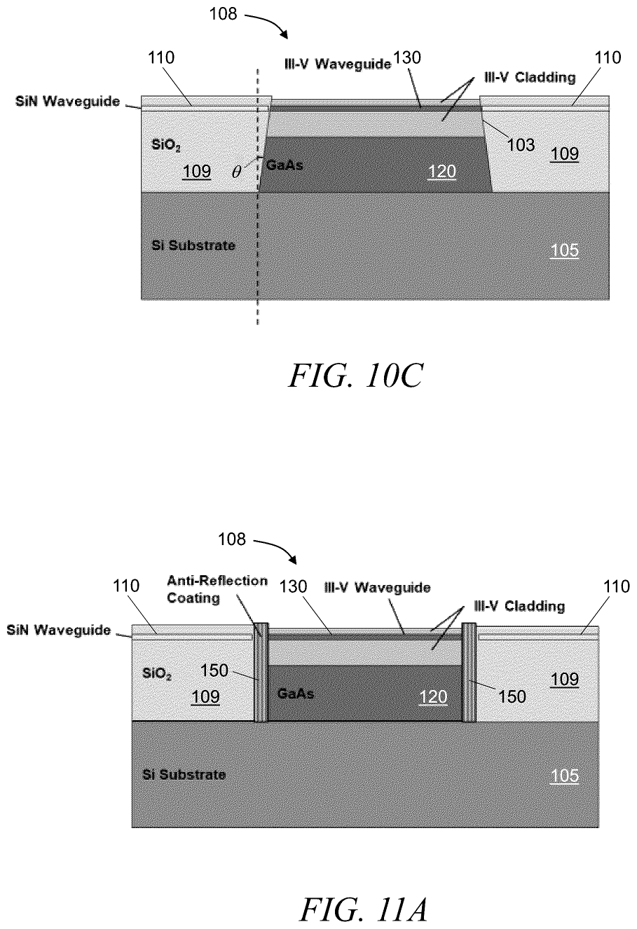

There are several ways in which the butt-coupling loss may be reduced. One way is depicted in FIG. 10A, which shows end sections of the first waveguide 110 and second waveguide 130 at the butt-coupling region. In this implementation, a central optical axis of the first waveguide 110 can be oriented at an angle, in an x-y plane parallel to the surface of the silicon wafer and the silicon substrate 105, to the central optical axis of the second waveguide 130. To inhibit unwanted {111} faceting in the growth region where the waveguides butt couple, the vertical walls of the trench 208 when etched for the III-V region 108 can be oriented such that a normal to the plane of the vertical wall points along the [110] direction. However, the walls of the trench 208 can be at an angle to the [110] direction (e.g., up to an angle such that the second waveguide 130 is aligned and/or runs parallel to the [110] direction. One trench wall is indicated by the white dashed line in FIG. 10A.

Calculations show that the interface return loss (plotted in FIG. 10B) can be reduced by butt coupling the waveguides 110, 130 at an angle as shown in FIG. 10A. When not coupled at an angle, the refractive index mismatch between SiNₓ and GaAs can result in about a 1 dB reflection (or −10 dB return loss) of the optical mode as the optical mode traverses the butt coupling transition from waveguide to waveguide. This amount of reflection may be too high for some applications, such as those in which the III-V region contains a laser or optical amplifier. The calculations of FIG. 10B show that angling the waveguides from 5 degrees to 7 degrees or more can reduce the Fresnel reflection and return loss to an acceptable level. In some implementations, the angle between the central optical axes of the butt-coupled waveguides 110, 130 can be at Brewster's angle (about 25 degrees for SiNₓ and GaAs) to minimize or eliminate facet reflections from the coupled ends of the waveguides.

Another approach to reducing facet reflections is to additionally or alternatively angle the waveguide facets in the vertical direction. FIG. 10C depicts vertically-angled facets at the butt-coupled ends of the first waveguide 110 and second waveguide 130. The walls 103 of the cladding material 109 can be under-etched (at an angle θ) to form sloped sidewalls in the trenches 208 where the III-V region 108 will be formed. The under-etching may be implemented by adjusting etch parameters (e.g., increasing gas pressure) to increase isotropic etching. In some cases, the under-etch angle θ can approximately or exactly match a crystal facet of the III-V material that is epitaxially grown in the trench 208. In another implementation, non-uniform growth across the trench 208 (as depicted in FIG. 3A) or a combination of under-etching and non-uniform growth across the trench can be used to angle the waveguide facets where they are butt coupled.

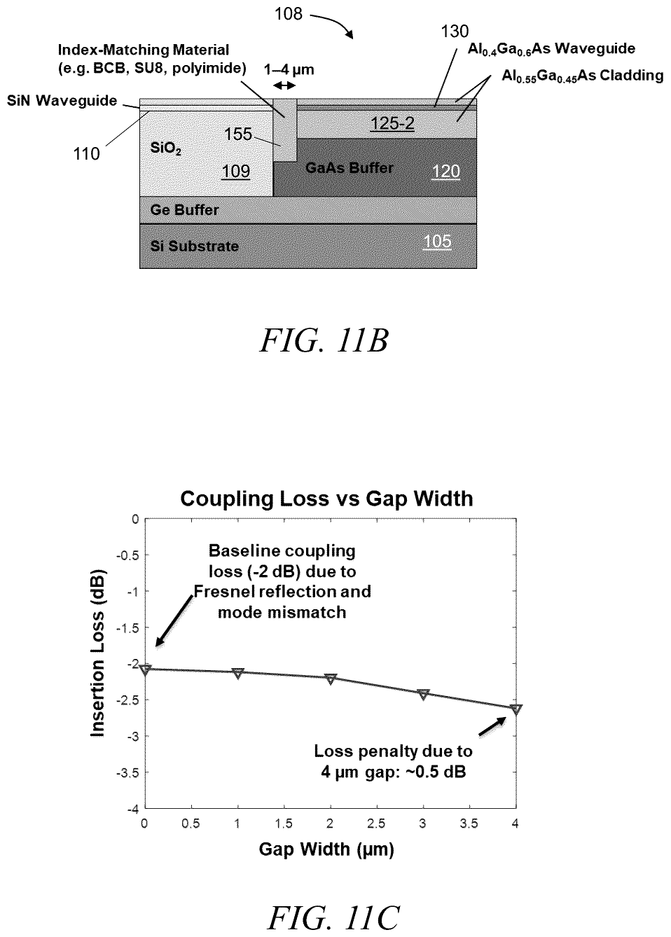

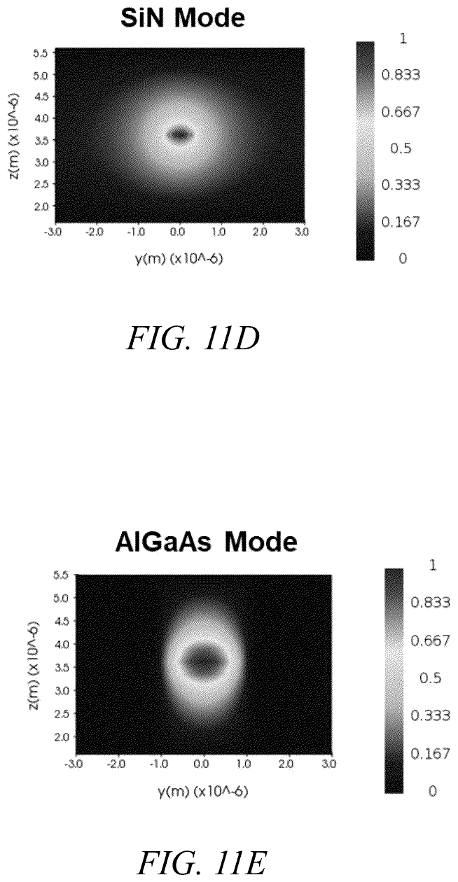

FIG. 11A depicts another approach to reducing facet reflections at the butt-coupled waveguides. An antireflection coating 150 can be deposited on vertical sidewalls of the trenches 208 in which the III-V region 108 is formed. The antireflection coating 150 may be a single layer or multiple layers of material that can be deposited using a conformal deposition process such as a conformal chemical vapor deposition process or an atomic layer deposition process.

FIG. 11B depicts another approach to reducing facet reflections and/or scattering losses at the coupled waveguides 110, 130. The presence of the amorphous dielectrics (SiO₂ and SiNₓ in this example) on the vertical walls at the dielectric/III-V interface disrupts crystal formation in the III-V region 108 during epitaxy. This disruption makes it difficult to obtain smooth planar facets at the ends of the second waveguide 130. In this approach, a portion of the structure that includes the butt-coupled facets can be removed (e.g., by etching or ion milling). Photolithography can be used to pattern a resist and expose the regions at the butt-coupled waveguides for removal. The width of the removed region can be from 0.2 microns to 4 microns wide or from 1 micron to 4 microns wide in some cases. After the material is removed, the resulting trench can be filled with a second filling material 155 having a selected index of refraction and that is transparent to the guided optical mode. The width of the removed region and the index of the filling material 155 can be selected to reduce reflections from the butt-coupling region. In some cases, the filling material 155 comprises index-matching material, that approximately matches the refractive index of the III-V waveguide or the SiNₓ (or other) waveguide. Example filling materials 155 include, but are not limited to, oxides such as SiO₂, and polymers such as polyimide, SU8 resist, polymethylmethacrylate (PMMA), and benzocyclobutene (BCB).

With an optical mode diameter of 1 micron or more in the waveguides 110, 130, the coupling region can tolerate an unguided mode across the width of the filling material 155 for up to several microns. FIG. 11C plots calculated insertion loss as a function of gap width for the structure of FIG. 11B. The optical modes used in simulations of the coupling between the waveguides are shown in FIG. 11D for the first waveguide 110 and in FIG. 11E for the second waveguide 130. The optical wavelength used for the simulation was 1550 nm. The baseline coupling loss of about −2 dB (due to mode mismatch) increases to only −2.5 dB with a 4-micron gap. This cut-and-fill approach can ease the requirements of the MOCVD III-V epitaxy process and enable III-V growth by molecular beam epitaxy (MBE), a process that would otherwise likely produce rough facets.

As may be appreciated, a variety of III-V devices can be integrated onto a wafer or chip using III-V/SiNₓ hybrid fabrication processes described above. For example, any one or combination of III-V emitters (lasers, LEDs, semiconductor optical amplifiers), electro-optic modulators, and photodetectors along with any silicon-based device or combination of silicon-based devices can be integrated onto a same wafer and/or chip via parallel microfabrication processes rather than pick-and-place chip-to-chip alignment and bonding. Also, structures other than waveguides can be fabricated (e.g., photodiodes having micron square areas or larger for detecting light incident on a surface of the chip, LED's and vertical cavity surface-emitting lasers for out-of-plane emission). There are many applications where III-V/SiNₓ hybrid integrated photonics can be employed. These applications include beam steering for solid-state LIDAR, hyperspectral imaging, high-power integrated lasers (>400 mW) and coherent beam combining for directed energy, microwave photonic signal processing, atomic and molecular optics, biological sensing (e.g., lab-on-chip devices), and optical transceivers for telecommunications and data communications. Atomic and molecular optical applications can include compact optical atomic clocks, ion-trap-based quantum computers and sensors, and neutral atom gyroscopes.

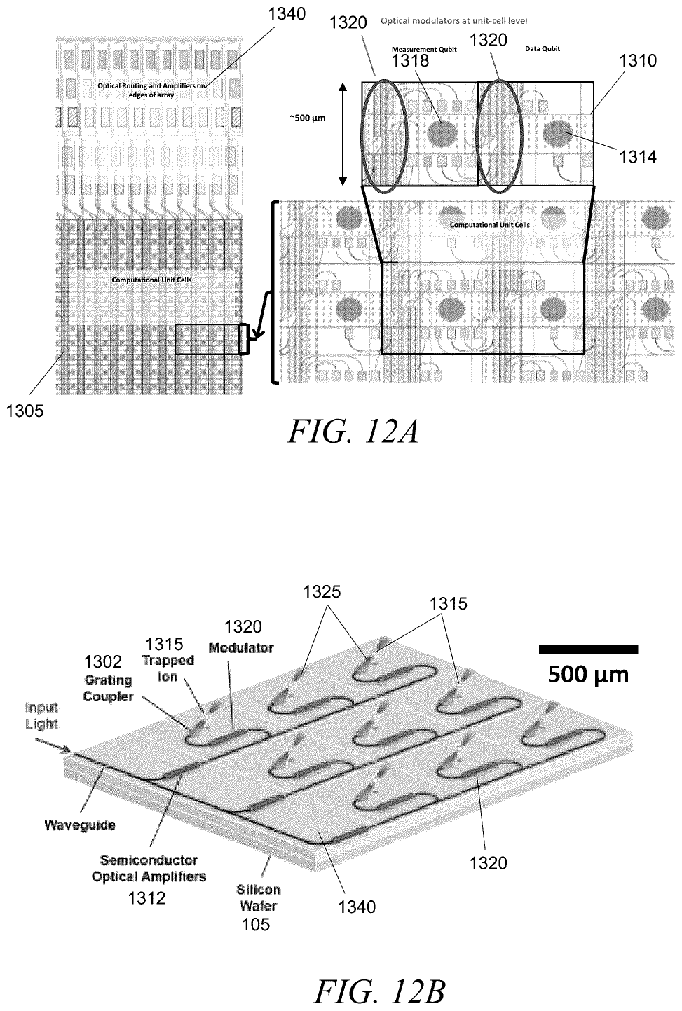

FIG. 12A depicts, in plan view, an application that involves ion trapping. Ion trapping for quantum computing and atomic clock applications is a significant and growing area of interest. The illustrated implementation of FIG. 12A and FIG. 12B includes an array 1305 of computational cells 1310 having trapped ions 1315. FIG. 12B depicts, in perspective view, a portion of the integrated photonic system of FIG. 12A and shows further details of the circuitry and trapped ions. Only one optical beam per trapped ion is shown but more than one beam can impinge on each ion. The ions can be trapped by electric fields (DC and/or RF electric fields) generated by metal electrodes patterned in the computational cell 1310. The light from the integrated photonics can be used for setting and reading out the quantum state of the ions, optical cooling, and/or other functions. The computational cells 1310 can be repeated for scalability and may allow 10³ to 10⁶ trapped ions per chip. There can be two or more trapped-ion qubits 1314, 1318 at each unit cell.

The computational cells 1310 can be provided with light (for ion trapping) and controlled, at least in part, using photonic devices 1340 (e.g., optical routing waveguides, emission devices, amplifying devices, and related electronics) integrated on the same silicon substrate 105 and located around and/or adjacent to the array 1305 of computational cells 1310. For example, an integrated laser can provide radiation into a waveguide that is coupled into a plurality of waveguides (using waveguide couplers or multimode interference couplers, for example). The divided radiation can be amplified in each waveguide using SOAs 1312 (see FIG. 3B) and delivered to one or more computational cells 1310. The optical routing and amplifying devices 1340 can be fabricated in parallel on the same substrate.

Each trapped ion 1315 for a qubit can be trapped in a potential well created by electric fields using electrodes patterned for each computational cell 1310. The light beams 1325 emitted from SESLs and/or SOAs 1312 of a III-V/SiNₓ hybrid integrated photonic circuit can be used to manipulate the valence state of the outermost electron (e.g., to initialize, manipulate, and/or read out the quantum state). Grating couplers 1302 can be used to deflect radiation out of the plane of the substrate and focus the emitted beams 1325. A first trapped ion can be used as a data qubit 1314 and a second trapped ion can be used as a measurement qubit 1318. Each trapped ion 1315 may be addressed by one or more light beams 1325. The unit cell can further include optical modulators 1320 comprising III-V semiconductor for qubit processing. Light provided to the computational cells 1310 can have a wavelength in a range from 290 nm to 1800 nm, which is suitable for trapping certain ions such as ytterbium, barium, calcium and strontium ions. For example, 674 nm radiation can be used to address strontium ions. Aluminum-gallium-arsenide-based optical devices and/or indium-aluminum-gallium-phosphide-based optical devices can be suitable for making optical modulators and/or optical amplifiers for much of this range of wavelengths.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A photonic integrated circuit comprising:
a silicon substrate;
a cladding material disposed on the silicon substrate;
a waveguide formed in the cladding material;
a III-V semiconductor material grown epitaxially on the silicon substrate bordering the cladding material; and
a III-V semiconductor waveguide formed in the III-V semiconductor material and butt-coupled to the waveguide.

2. The photonic integrated circuit of claim 1, wherein the silicon substrate is a (100) silicon substrate with a 6° offcut towards a nearest <111> direction of the silicon substrate.

3. The photonic integrated circuit of claim 1, wherein the cladding material comprises an oxide.

4. The photonic integrated circuit of claim 1, wherein the waveguide comprises at least one of silicon, silicon nitride, germanium, lithium niobate, aluminum oxide, or titanium oxide.

5. The photonic integrated circuit of claim 1, wherein the III-V semiconductor waveguide has a threading dislocation density of about 1×10⁶ cm⁻² to about 1×10⁹ cm².

6. The photonic integrated circuit of claim 1, wherein a coupling loss between the waveguide and the III-V semiconductor waveguide is less than or equal to 10 dB.

7. The photonic integrated circuit of claim 1, wherein at least one of the waveguide or the III-V semiconductor waveguide is oriented parallel to a [110] direction of the silicon substrate.

8. The photonic integrated circuit of claim 1, wherein at least one of the waveguide or a facet between the III-V semiconductor material and the cladding material is angled with respect to the III-V semiconductor waveguide.

9. The photonic integrated circuit of claim 1, further comprising a trench containing material disposed between a first end of the waveguide and a second end of the III-V semiconductor waveguide that butt-couple to each other to reduce reflections from the butt-coupled waveguide and semiconductor waveguide.

10. The photonic integrated circuit of claim 1, wherein the waveguide is patterned to reduce back reflections and/or to increase coupling into the III-V semiconductor waveguide.

11. The photonic integrated circuit of claim 1, further comprising:
a germanium layer disposed between the silicon substrate and the III-V semiconductor waveguide.

12. The photonic integrated circuit of claim 1, further comprising:
a dislocation filter disposed in the III-V semiconductor material between the silicon substrate and the III-V semiconductor waveguide.

13. The photonic integrated circuit of claim 1, further comprising:
electrical contacts in electrical communication with the III-V semiconductor material,
wherein the III-V semiconductor material forms at least a portion of a laser, a semiconductor optical amplifier, an optical modulator, or a photodetector.

14. The photonic integrated circuit of claim 1, further comprising:
electrical contacts in electrical communication with the III-V semiconductor material, wherein the III-V semiconductor material forms a semiconductor laser; and
an optical component to direct light from the semiconductor laser out of a plane of the silicon substrate to form a surface-emitting semiconductor laser.

15. A method of making a photonic integrated circuit, the method comprising:
depositing a first cladding layer on a silicon substrate;
forming a first waveguide on the first cladding layer;
depositing a second cladding layer on the first waveguide;
etching a trench through the second cladding layer, at least a portion of the first waveguide, and the first cladding layer, wherein etching through the first waveguide forms a first end of the first waveguide;
epitaxially growing a III-V semiconductor material in the trench; and
forming a second waveguide from at least a portion of the III-V semiconductor material, the second waveguide having a second end that is vertically aligned with and butt-coupled to the first end of the first waveguide.

16. The method of claim 15, wherein etching the trench comprises etching the trench at least partially into the silicon substrate.

17. The method of claim 15, further comprising:
forming electrical contacts in electrical communication with the III-V semiconductor material.

18. The method of claim 15, wherein the silicon substrate is (100) oriented and offcut at an angle towards a nearest <111> direction of the silicon substrate.

19. The method of claim 15, wherein epitaxially growing the III-V semiconductor material comprises growing gallium arsenide at a temperature between 550 degrees Celsius and 610 degrees Celsius.

20. The method of claim 15, further comprising forming at least one of grooves, microscale patterns, or sub-microscale patterns in the trench to suppress anti-phase domain formation in the III-V semiconductor material.
